(19) United States
(12) Patent Application Publication
(10) Pub. No.: US 2015/0052681 A1
(43) Pub. Date: Feb. 26, 2015

(54) Toileting Sling System and Method for Incontinence Protection

(71) Applicant: Crescia Hagler, St. Paul, MN (US)

(72) Inventor: Crescia Hagler, St. Paul, MN (US)

(21) Appl. No.: 14/460,135

(22) Filed: Aug. 14, 2014

Related U.S. Application Data
(60) Provisional application No. 61/959,411, filed on Aug. 23, 2013.

(51) Int. Cl. A61G 7/10

(52) U.S. Cl. CPC A61G 7/1073; A61G 7/1051; A61G 2200/34
USPC 5/89.1

(57) ABSTRACT

A transfer sling comprises (a) a sling body portion including: (i) a plurality of positioning straps to promote patient position adjustment, and (ii) a commode opening for toileting activities; and (b) a pair of protection straps generally disposed on opposite sides of the commode opening, the protection straps extending laterally across the width of the commode opening and adapted to receive opposite ends of an absorbent incontinence sheet positionable between the protection straps to fully cover the commode opening.

### FIELD OF THE DISCLOSURE

The invention relates generally to a toileting sling and methods for minimizing the adverse effects of incontinence events during use of a toileting sling, and more particularly in one exemplary embodiment, to systems and methods including an absorbent pad removably positionable proximate a toileting sling commode opening for toileting activities.

### BACKGROUND

Fecal incontinence (i.e., the involuntary excretion of bowel contents) and urinary incontinence (i.e., the involuntary excretion of urine) (hereafter referred to collectively as “incontinence”) are two undesirable medical conditions, particularly for non-ambulatory individuals. Such persons need to be transferred from bed or chair to a commode utilizing a lift and a transfer sling.

A variety of transfer slings are available commercially. Some are constructed with an opening to promote easy access to a commode or toilet. However, if a non-ambulatory person becomes incontinent during the transfer process, a caregiver may have little choice but to hurry to push the lift and sling into position over the commode seat. Most likely, the caregiver will be faced with the clean up of a toileting accident on a bed, chair, floor, carpet, etc.

Hurrying a patient transfer and having to clean up a toileting accident are undesirable for many reasons. In such cases, patient dignity suffers. Accordingly, there remains a need for an improved system and method for the transfer of non-ambulatory patients that minimizes the adverse effects of incontinence events during the toileting process.

### SUMMARY

The present disclosure provides toileting sling systems and methods. In one exemplary embodiment, a transfer sling comprises (a) a sling body portion including: (i) a plurality of positioning straps to promote patient position adjustment, and (ii) a commode opening for toileting activities; and (b) a pair of protection straps generally disposed on opposite sides of the commode opening, the protection straps extending laterally across the width of the commode opening and adapted to receive opposite ends of an absorbent incontinence sheet positionable between the protection straps to fully cover the commode opening.

Other benefits and advantages of the present disclosure will be appreciated from the following detailed description.

### DESCRIPTION OF THE DRAWINGS

FIG. 1 is a plan view of a prior art embodiment of a toileting sling with a commode opening.

FIG. 2 is a bottom plan view of an exemplary embodiment of a toileting sling with a commode opening including exemplary protection straps.

FIG. 3 is a bottom plan view of an exemplary embodiment of a toileting sling with a commode opening including an exemplary absorbent incontinence sheet positioned between the exemplary protection straps shown in FIG. 2.

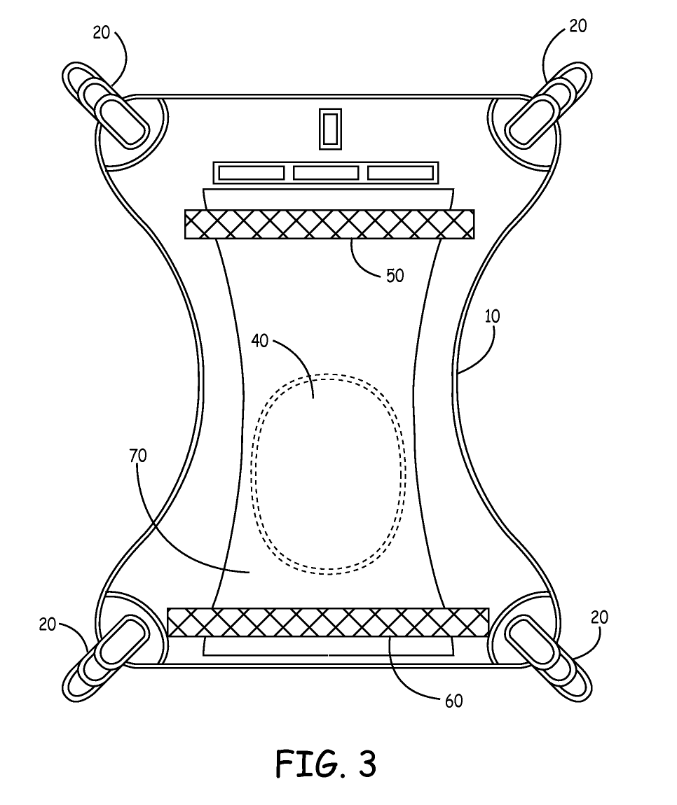

FIG. 4 is a perspective schematic view of an exemplary embodiment of a toileting sling system comprising a lift and a toileting sling including an exemplary absorbent incontinence sheet positionable between exemplary protection straps.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to incontinence protection; etc. Such aspects related to this disclosure do not depart from the invention, and it is therefore intended that the invention not be limited by the certain aspects set forth of the events and circumstances related to this disclosure.

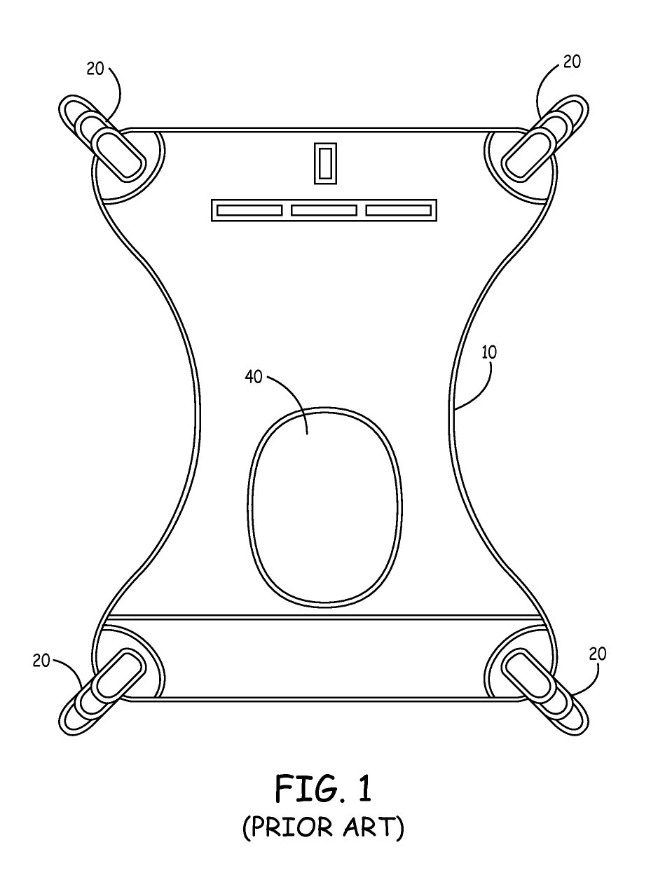

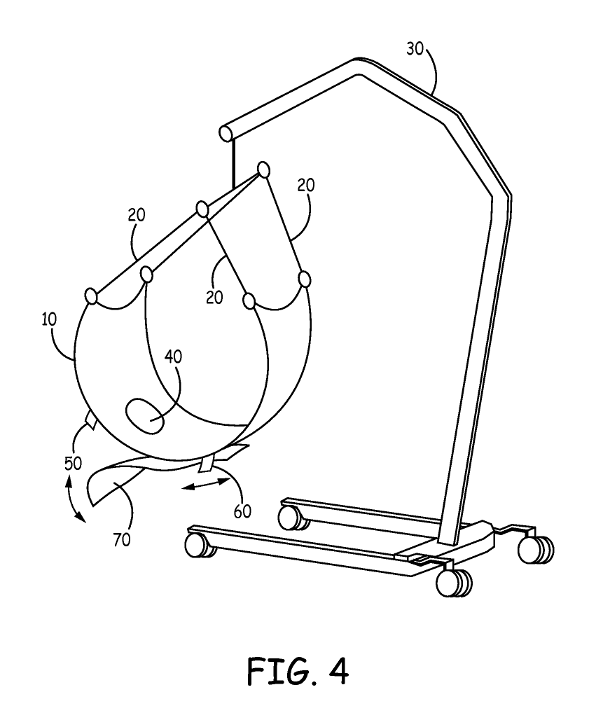

Turning now to the drawings, FIG. 1 shows an exemplary prior art transfer sling 10. The sling 10 as shown includes a plurality of positioning straps 20. The positioning straps 20 are adapted to engage with a lift 30 (see FIG. 4), and may be adjustable to promote the positioning or repositioning of a patient for a toileting transfer process.

The sling 10 includes a generally centrally disposed commode opening 40. When a patient or individual positioned within the sling 10 becomes incontinent, bowel contents and/or urine may pass through the opening 40 and into a commode or toilet.

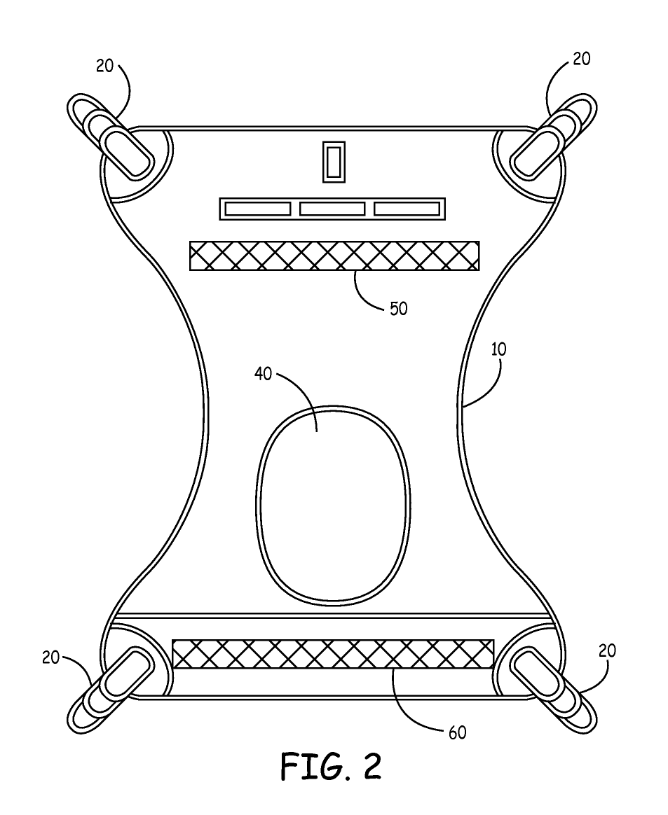

As shown in FIG. 2, the sling 10 includes a pair of incontinence protection straps 50, 60. The protection straps 50, 60 are generally disposed on opposite sides of the commode opening 40. In one exemplary embodiment, the protection strap 50 is disposed proximate a top portion of the sling 10, and the protection strap 60 is disposed proximate a bottom portion of the sling 10.

In one exemplary embodiment, the protection straps 50, 60 are generally elongated fabric portions that extend laterally beyond the width of the commode opening 40. Each strap 50, 60 may be secured to the sling 10 at the strap's first and second ends. In one embodiment, the straps 50, 60 may be permanently affixed to the sling 10 at one or more of their first and second ends, e.g., by stitching, rivots, or other permanently securing means. In an alternate exemplary embodiment, the straps 50, 60 may be made of a non-fabric (e.g., a plasic or rubber strip, or other suitable means for holding) and may be removably secured to the sling 10 at one or more of their first and second ends, e.g., by hooks, loops, clips, or the like. Various combinations of fasteners to secure the first and second ends of the straps 50, 60 may be used.

The straps 50, 60 generally are sized so that opposite ends of an absorbent incontinence sheet may be tucked between the sling 10 and the straps 50, 60 (at locations between their first and second ends). The exact sizes of the straps 50, 60 may vary depending upon the size of the sling 10, the size of the commode opening 40, and other circumstances involved in a particular application. In one exemplary embodiment, straps 50, 60 may range from 1-2 inches wide and from 20-30 inches in length. The straps 50, 60 may be made of a heavy duty, tear-proof material (e.g., a mesh-type fabric), and may be double-stitched at each end for strength.

A transfer sling 10 with incontinence protection straps 50, 60 may be used most easily when a patient or individual is not wearing a diaper, underwear, or other garment. Once the person is lifted from her bed, chair, commode, etc., a disposable absorbent pad 70 may be inserted from beneath between the two protection straps 50, 60. Starting from the rear, a first end of absorbent pad 70 is secured at protection strap 60 by insertion under the strap 60. The absorbent side of the pad 70 faces the sling 10. The commode opening 40 is covered by the pad 70, and then the opposite side of the pad 70 is inserted beneath the protection strap 50 proximate the top of the sling 10. After the pad 70 is in place and secured, the caregiver is then free to move the person about with the lift and sling without any incontinence accidents.

Over the commode, the caregiver may gently pull down the pad 70 from the rear. If unsoiled, the rear portion of the pad 70 may be tucked around into the front strap 50 until toileting is complete. Afterwards, the rear portion of the pad 70 may be returned to a securely affixed at the rear strap 60. If soiled, the pad 70 may be removed carefully at both ends simultaneously. The soiled pad is then discarded and replaced with a new pad once toileting is complete.

In an alternate embodiment, the straps 50, 60 may engage with the pad 70 using a Velcro^{TM} hook and loop fastening system. In such case, the straps 50, 60 may be affixed to the sling 10 along all or a portion of their lengths, so that fastening of the pad 70 may occur along all or a portion of the length of the straps 50, 60. Of course, the hook and loop fastening system also may be positioned to correspond to various locations about the periphery of the absorbent pad 70, i.e., about the commode opening 40 on two or more sides.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. A transfer sling including: (a) a sling body portion comprising: (i) a plurality of positioning straps to promote patient position adjustment, and (ii) a commode opening for toileting activities; and (b) a pair of protection straps generally disposed on opposite sides of the commode opening, the protection straps extending laterally across the width of the commode opening and adapted to receive opposite ends of an absorbent incontinence sheet positionable between the protection straps to fully cover the commode opening.

2. The transfer sling of claim 1, wherein a protection strap is secured to the sling body portion at a first end of the protection strap.

3. The transfer sling of claim 2, wherein the protection strap is secured to the sling body portion at a second end of the protection strap opposite the first end.

4. The transfer sling of claim 1, wherein the protection strap is formed as part of a hook and loop fastening system.

5. The transfer sling of claim 1, including an absorbent pad covering the commode opening.

6. The transfer sling of claim 5, wherein a first end of the absorbent pad is tucked beneath a protection strap.

7. The transfer sling of claim 5, wherein opposites sides of the absorbent pad are tucked respectively under protection straps disposed on opposite sides of the commode opening.
